(19) United States
(12) Patent Application Publication
(10) Pub. No.: US 2022/0132235 A1
(43) Pub. Date: Apr. 28, 2022

(54) Use the Case of Wireless Earbuds as Audio Transmitter

(71) Applicant: Google LLC, Mountain View, CA (US)

(72) Inventor: Chen Wang, Mountain View, CA (US)

(21) Appl. No.: 17/498,900

(22) Filed: Oct. 12, 2021

Related U.S. Application Data
(60) Provisional application No. 63/106,161, filed on Oct. 27, 2020.

(51) Int. Cl. H04R 1/10; H04R 1/02

(52) U.S. Cl. CPC H04R 1/1041; H04R 2420/07; H04R 1/02; H04R 1/1016

(57) ABSTRACT

Though some basic electronic devices are not enabled for wireless pairing with audio accessories, such as earbuds, the present disclosure provides a mechanism for adapting such basic electronic devices. In particular, a wireless pairing transceiver is integrated into a case for the audio accessory. The case can be physically electronically connected to the basic audio device through a speaker jack in the basic audio device. Accordingly, audio signals from the basic electronic device can be output to the case and then wirelessly transmitted to the accessory. Similarly, audio input from the wireless accessory can be wirelessly transmitted to the case and then relayed to the basic electronic device.

### CROSS-REFERENCE TO RELATED APPLICATIONS

The present application claims the benefit of the filing date of U.S. Provisional Patent Application No. 63/106,161 filed Oct. 27, 2020, the disclosure of which is hereby incorporated herein by reference.

### BACKGROUND

Fully wireless earbuds are desirable in that they provide users with freedom of movement without becoming entangled. To use the wireless earbuds, they establish short range wireless pairing with an audio source. Examples of such audio sources include, for example, phones, laptop computers, etc. Wireless earbuds become useless if the audio source only has a speaker output jack, such as audio output from airplane seats and many desktop computers.

### BRIEF SUMMARY

The present disclosure provides for integrating a short range wireless pairing, e.g., Bluetooth®, transceiver into a case for wireless earbuds or other wearable audio output devices. The case can be electronically connected, using a physical cable connector or other physical connector, to a speaker jack of a simple electronic device that is not wireless pairing enabled. Accordingly, the case can forward audio signals from the simple electronic device to the earbuds. Similarly, in some instances the case can forward audio input from the earbuds, such as from a microphone in the earbuds, to the simple electronic device. By integrating wireless pairing capabilities into the case, the wireless earbuds can be used for all types of audio devices, including those without native wireless pairing support.

One aspect of the disclosure provides a case for a wireless accessory, comprising a housing for receiving the wireless accessory, a battery, an input adapted to receive content from a simple electronic device through a physical connection, and a short range wireless pairing transmitter configured to relay the received content to the wireless accessory over a wireless pairing connection. According to some examples, the case may further include one or more processors configured to detect when the physical connection to the simple electronic device is complete, and automatically transmit the received content to the wirelessly accessory upon detecting that the physical connection is complete. The battery may be adapted to charge the wireless accessory when the wireless accessory is received within the housing. According to some examples, the input comprises a port adapted to receive a connector cable. According to other examples, the input comprises a connector integral with the case.

The short range wireless pairing transmitter may be adapted to transmit the received content to additional output devices. For example, the short range wireless pairing transmitter may be configured to multicast the received content to multiple wireless accessories at a given time. According to some examples the case comprises one or more processors configured to detect a presence of an additional wireless accessory, and provide a prompt for instructions whether to transmit the received audio to the additional wireless accessory. The short range wireless pairing transmitter may include a transceiver configured to receive input from the wireless accessory over the wireless connection.

In some implementations, the case may be configured to relay the received input to another device. The case may further include one or more processors configured to execute a command instructed by the received input.

Another aspect of the disclosure provides a system, comprising a wireless accessory and a case for the wireless accessory. The case may include a battery, an input adapted to receive content from a simple electronic device through a physical connection, and a short range wireless pairing transmitter configured to relay the received content to the wireless accessory over a wireless pairing connection. The case may further include one or more processors configured to detect when the physical connection to the simple electronic device is complete, and automatically transmit the received content to the wirelessly accessory upon detecting that the physical connection is complete.

In some implementations, the input may include a port adapted to receive a connector cable. The short range wireless pairing transmitter may be adapted to transmit the received content to additional output devices. The short range wireless pairing transmitter may be configured to multicast the received content to multiple wireless accessories at a given time.

According to some examples, the case may include one or more processors configured to detect a presence of an additional wireless accessory, and provide a prompt for instructions whether to transmit the received audio to the additional wireless accessory.

Another aspect of the disclosure provides a method, comprising detecting a physical connection between a case for a wireless electronic accessory and a simple electronic device, receiving, at the case over the physical connection, content output from the simple electronic device, and automatically transmitting, by the case, the received content over a short range wireless pairing connection to the wireless accessory. The method may further include multicasting the received content to multiple wireless accessories at a given time. The method may further include detecting a presence of an additional wireless accessory, and providing a prompt for instructions whether to transmit the received audio to the additional wireless accessory.

### BRIEF DESCRIPTION OF THE DRAWINGS

FIG. 1 is a pictorial diagram illustrating an example system according to aspects of the disclosure.

FIG. 2 is a block diagram of an example case according to aspects of the disclosure.

FIGS. 3A-3B are pictorial diagrams illustrating example implementations of the system according to aspects of the disclosure.

FIG. 4 is a pictorial diagrams illustrating another example implementation of the system according to aspects of the disclosure.

FIG. 5 is a flow diagram illustrating an example method according to aspects of the disclosure.

### DETAILED DESCRIPTION

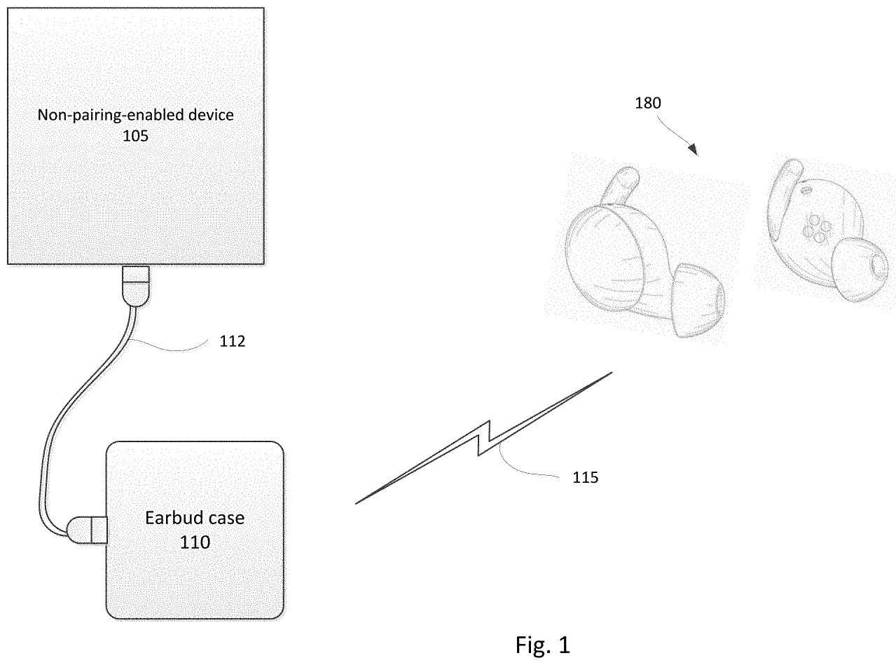

FIG. 1 illustrates an example implementation of a case 110 for a wireless auxiliary device 180, wherein the case is enabled with a short range wireless transceiver that allows for wireless communication with the auxiliary device 180. In this regard, the case may be physically electronically connected to a simple electronic device, such as non-pairing-enabled device 105. The case 110 may therefore relay communication between simple device 105 and the fully wireless auxiliary device 180, despite that the simple device 105 is not enabled for wireless pairing.

The simple electronic device 105 may be any non-pairing-enabled device. For example, the simple device 105 may be an airplane television, a desktop computer, a gaming system, an older electronic device such as a CD player, or any of a plurality of other electronic devices that are not wireless pairing enabled.

The physical electronic connection between the simple device 105 and the case 110 may be established using a cable connector 112 or other types of connectors. The cable may include a speaker jack connector at a first end for engaging a port of the simple electronic device 105. According to other examples, the first end of the cable may include any of a variety of other types of connectors compatible with common simple devices. A second, opposite end of the cable may be configured for engaging a port of the case 110. For example, the second end may include a USB-C connector or any other type of connector. In some implementations, the case 110 may be connected to the simple device 105 without a cable. For example, the case 110 may have a speaker jack connector integrated therewith.

The case 110 may include a housing for receiving the auxiliary device 180. For example, the case 110 may have a clamshell configuration adapted to be opened such that the auxiliary device 180 can be received therein. While this is merely one example, it should be understood that the housing of the case 110 may take many shapes and forms, any of which can accommodate the auxiliary device 180, which can also take many shapes and forms.

The case 110 may include a battery adapted to charge the auxiliary device 180 when the auxiliary device 180 is housed therein. As such, a user of the auxiliary device 180 may keep the case 110 nearby when the auxiliary device 180 is in use, and carry the case 110 with them in the event recharging is needed.

The case 110 may further include an input port for receiving the connector 112. The input port may be any of a variety of types of input ports, such as USB-A, USB-B, USB-C, micro USB, lightning cable, etc.

As shown in FIG. 1, the auxiliary device 180 may be a pair of wireless earbuds. However, it should be understood that the auxiliary device 180 may be any of a variety of other types of device. For example, the auxiliary device 180 may be smartglasses, a head mounted display, an audio headset, a smart helmet, a pendant, etc.

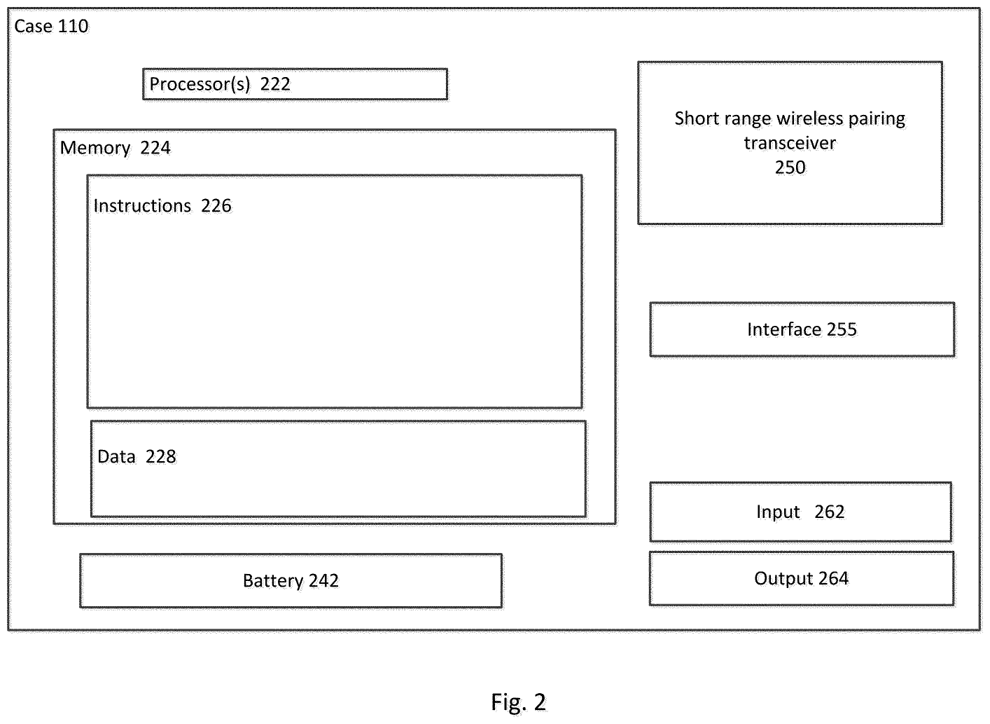

FIG. 2 provides an example block diagram illustrating components of the case 110. In the example shown, the case 110 includes various components, such as short range wireless pairing transceiver 250, battery 242, input 262, output 264, etc. The case 110 may further include one or more processors 222, memory 224, and other components typically present in microprocessors, general purpose computers, or the like.

The short range wireless pairing transceiver 250 enables the case 110 to wirelessly couple with an auxiliary device, such as earbuds, a headset, a head-mounted display, or other wearable technology devices. The short range wireless pairing transceiver 250 may also enable communication with other equipped devices, such as a smartphone, laptop, tablet, music player, or the like. The wireless coupling may be established using any of a variety of techniques, such as Bluetooth, Bluetooth low energy (BLE), etc.

The battery 242 may provide power to the components of the case 110. In some examples, the battery 242 may also be used to charge a battery of the auxiliary device. For example, when the auxiliary device is stored within the case 110, the auxiliary device may be charged by the battery 242. The charging may be automatic depending on one or more conditions, such as presence and/or battery level of the auxiliary device within the case, or may be controlled manually such as with a switch.

The case 110 may further include an interface 255. The interface 255 may provide for communication with other devices, such as simple electronic devices that are not enabled for wireless pairing. The interface 255 may include, for example, one or more input/output ports, a connector, a cable, or any other mechanism used for establishing communication between the case 110 and the simple electronic device.

The input 262 and output 264 may be used to receive information from a user and provide information to the user. The input may include, for example, one or more buttons or other touch sensitive inputs, a microphone, etc. The output 264 may include, for example, a speaker adapted to provide audible output to the user, a display, an indicator light, etc. According to some examples, input and output may be omitted from the case 110.

The one or more processor 222 may be any conventional processors, such as commercially available microprocessors. Alternatively, the one or more processors may be a dedicated device such as an application specific integrated circuit (ASIC) or other hardware-based processor. Although FIG. 2 functionally illustrates the processor, memory, and other elements of case 110 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of case 110.

Memory 224 may store information that is accessible by the processors 222, including instructions 226 that may be executed by the processors 222, and data 228. The memory 224 may be of a type of memory operative to store information accessible by the processors 222, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 226 and data 228 are stored on different types of media.

Data 228 may be retrieved, stored or modified by processors 222 in accordance with the instructions 226. For instance, although the present disclosure is not limited by a particular data structure, the data 228 may be stored in computer registers, in a relational database as a table having a plurality of different fields and records, XML documents, or flat files. The data 228 may also be formatted in a computer-readable format such as, but not limited to, binary values, ASCII or Unicode. By further way of example only, the data 228 may be stored as bitmaps comprised of pixels that are stored in compressed or uncompressed, or various image formats (e.g., JPEG), vector-based formats (e.g., SVG) or computer instructions for drawing graphics. Moreover, the data 228 may comprise information sufficient to identify the relevant information, such as numbers, descriptive text, proprietary codes, pointers, references to data stored in other memories (including other network locations) or information that is used by a function to calculate the relevant data.

The instructions 226 may be executed to perform operations, such as receiving audio output from a simple electronic device through the interface, and relaying the received audio to the auxiliary device using the short range wireless transceiver 250. Moreover, the instructions 226 may provide for receiving input from the auxiliary device through the short range wireless transceiver 250, and relaying such input to the simple electronic device.

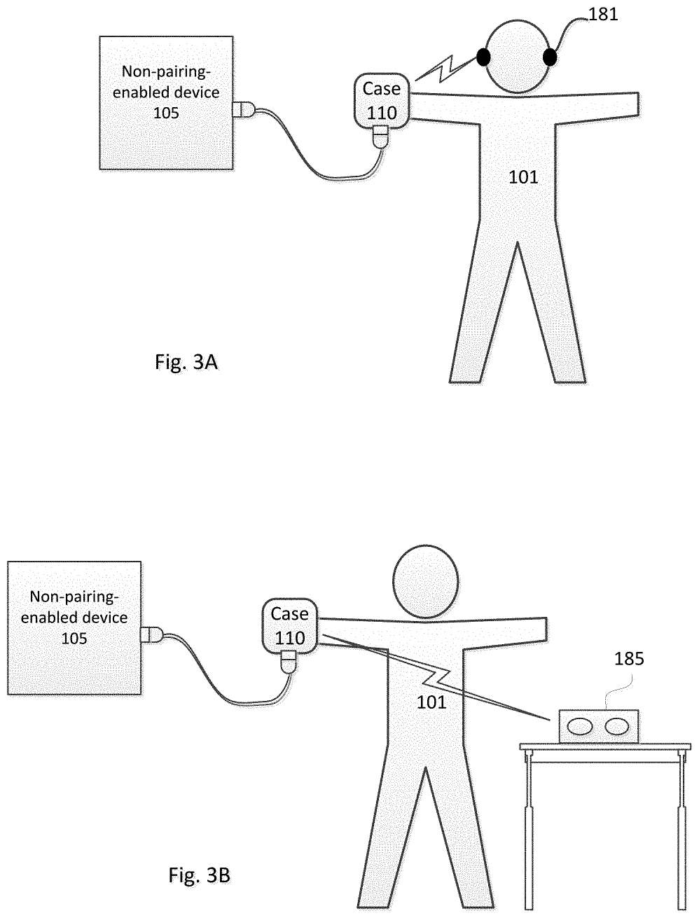

According to some examples, the instructions may be executed to relay the output from the simple electronic device to multiple auxiliary devices. For example, the memory 224 may store pairing information for multiple accessories. Such accessories may include multiple accessories belonging to the same user, or accessories of multiple users such as in the examples described in connection with FIGS. 3A-B, 4 below.

The instructions may further provide for detecting when the case 110 is coupled to a simple electronic device, and automatically relaying output from the simple device to the auxiliary device. For example, the auxiliary device may be paired with a different device, such as a phone, to accept output from the phone over the short range wireless pairing. However, once connection between the case 110 and the simple device 105 is detected by the case 110, the case may send a signal to the auxiliary device 180 to switch its pairing to the case 110. In some examples, rather than automatically switching, the case 110 may prompt the user to switch the connection. Such prompts may include, by way of example, an output on the case 110, such illumination of a light, display of text, haptic feedback such as a vibration, or any other type of notification. In other examples, such prompt may be transmitted through the auxiliary device, such as by playing a tone or through an audio message instructing the user to perform a particular operation to switch the pairing of the auxiliary device 180.

It should be understood that the case 110 may include other components which are not shown, such as charging input for the battery, signals processing components, etc. Such components may also be utilized in execution of the instructions 226.

FIG. 3A illustrates an example use case where user 101 is wearing earbuds 181 that are wirelessly paired with the case 110. The pairing between the earbuds 181 and the case 110 may be performed in a factory setting, such that when the user 101 receives the earbuds 181 and case 110 they are already paired. In other examples, the user 101 may establish the pairing connection between the two, such as by entering input on the earbuds 181, case 110, or both.

In the example of FIG. 3A, the user 101 desires to use the earbuds 181 to output audio content from simple electronic device 105, which is not wireless pairing enabled. For example, the simple device 105 may be a television, computer, radio, or other device that does not have a short range wireless pairing transmitter. The device 105 may have, however, a port for providing audio output to a pair of wired headphones or a wired speaker. The port may be, for example, a digital or analog audio output port. The user 101 establishes a connection between the case 110 and the simple electronic device 105 by connecting cable 112 at one end into the port of the simple electronic device 105 and connecting the other end of the cable 112 to the case 110. According to some examples, the case 110 may detect the connection to a simple electronic device 105. Accordingly, the case 110 may automatically begin relaying output received from the simple device 105 through the cable 112 to the earbuds 181 over the short range wireless pairing connection.

According to some examples, in addition or alternative to relaying output from the simple device 105 to the earbuds 181, the case 110 may receive input from the earbuds 181. For example, the earbuds 181 may include a microphone for capturing the user's voice input. The case 110 may relay the input from the earbuds 181 to the simple device 105. According to other examples, the case 110 may process the received input as a command. For example, the received input may be a voice command to search for pairing with other nearby devices.

FIG. 3B illustrates another example, where the case 110 may be used to relay the output from the simple electronic device 105 to another output, such as to speakers 185. For example, the user may connect the case 110 to the device 105 as described above, such as by using a cable or a connector integrated with the case 110. The user may further initiate wireless pairing between the speakers 185 and the case 110. For example, the user may perform one or more operations, such as bringing the devices within a predetermined distance of one another, pressing a pairing button on one or both devices, etc.

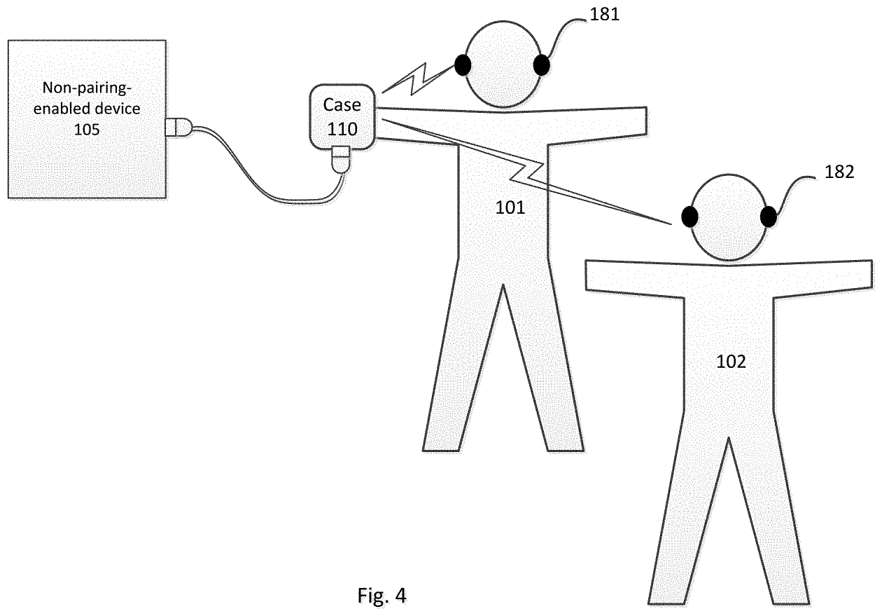

FIG. 4 illustrates another example, where the case 110 multicasts output from the simple electronic device 105 to multiple auxiliary devices at a same time. For example, as shown, users 101 and 102 may each have their own pair of earbuds 181, 182, respectively. For example, the users 101, 102 may be sitting near each other and viewing the same content on the simple device 105. The case 110 may operate in a multicast mode, where it relays the output from the simple device 105 to both sets of earbuds 181, 182. According to some examples, the user 101 may switch the case 110 to the multicast mode by entering input on the case. According to other examples, the case 110 may detect a presence of multiple sets of earbuds 181, 182 within a predetermined range. In such examples, the case 110 may ask whether it should operate in multicast mode. For example, an indication of potential multicast mode may be delivered through the case 110 or through the earbuds 181. The indication may be, for example, a message identifying that nearby wireless pairing enabled devices are detected. In some examples, the message may identify the devices by type or name, and the user may select which devices should receive the wirelessly transmitted audio output. If a positive response is received from the user 101, the case 110 may begin multicast of the content from the simple electronic device.

Where the case is configured to receive input from the earbuds 181, the case may be further configured to transmit the received input to other devices. For example, the case may transmit input from the earbuds 181 to the earbuds 182.

While the examples above primarily describe the relay of audio output from a simple device to earbuds or other audio output devices, it should be understood that other types of content may be relayed as well. For example, the case may be used to relay video, data, or other types of information to any of a variety of types of wireless pairing enabled devices. Moreover, while the examples above describe relaying content from a simple device that lacks wireless pairing capabilities, it should be understood that the case may be used to relay content even if the simple device has wireless pairing capability. For example, rather than the user going through steps to pair his accessory to the device, the user can plug his case into the device to relay the content, since the user's case may already be wirelessly paired to the accessory.

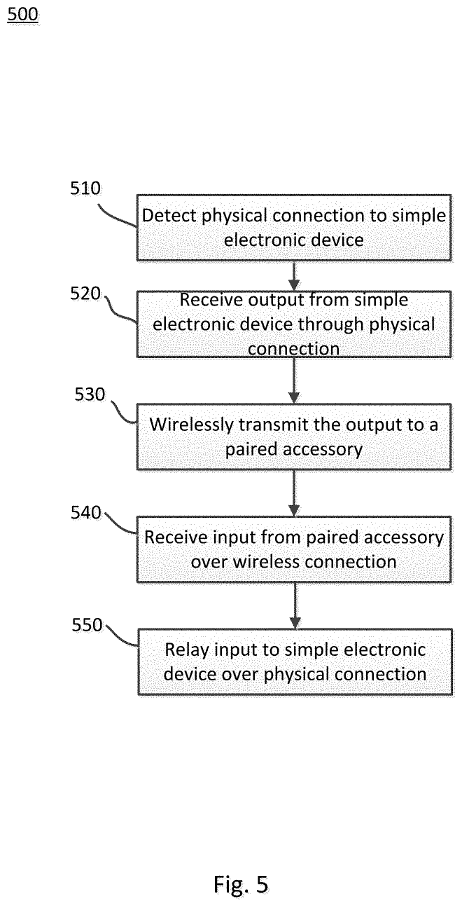

FIG. 5 illustrates an example method 500 for using a case of a wireless accessory to wirelessly transmit content from a simple electronic device to the wireless accessory. While the operations are described below in a particular order, it should be understood that operations may be performed in a different order or simultaneously. Moreover, operations may be added or omitted.

In block 510, the case detects a physical electrical connection to a simple electronic device. The simple electronic device may be any device that is not equipped with short range wireless pairing capabilities, such as older generation televisions, radios, etc. According to some examples, the simple electronic device may have wireless pairing ability, but the case may nevertheless be used for pairing. For example, rather than a user going through steps required to pair the user's earbuds to another device, the user may simply connect the case that is already paired to the other device.

The physical connection may be established using, for example, a cable connected to an output port of the simple device and a port of the case. For example, the cable may have a speaker jack at a first end which is inserted into an audio output port of the simple device. According to other examples, the physical connection may be established by a connector integrated with the case. The case may detect the presence of the simple device when the electrical connection is complete.

In block 520, the case receives output from the simple electronic device through the physical connection. For example, the output may be audio content, video content, or any other type of content.

In block 530, the case wirelessly transmits the received output to a paired accessory. For example, the case may be automatically paired with earbuds or another type of accessory, and the earbuds and case may be shipped and sold together such that they are paired when taken out of the box. In other examples, the case may be paired with an accessory that was not shipped and sold with the case. For example, the case may be paired with a wireless speaker or other device. Moreover, the case may multicast the output to multiple devices at a same time. For example, multiple users can arrange to receive the content over individual pairs of earbuds.

In some examples, the case may further receive input from the accessory over the wireless connection (block 540) and relay the input to the simple electronic device over the physical connection (block 550).

Using the case for a wireless accessory to relay content from a simple device can be advantageous in that it enables the user to enjoy the content through the accessory, without requiring that the user carry around additional devices dedicated to the relaying. Moreover, as many accessories, such as earbuds, are already paired with the case when purchased by the user, physically connecting the case to a device to receive the content wirelessly through the accessory may be faster and easier than attempting to pair the accessory directly to the device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A case for a wireless accessory, comprising:
a housing for receiving the wireless accessory;
a battery;
an input adapted to receive content from a simple electronic device through a physical connection; and
a short range wireless pairing transmitter configured to relay the received content to the wireless accessory over a wireless pairing connection.

2. The case of claim 1, further comprising one or more processors configured to:
detect when the physical connection to the simple electronic device is complete; and automatically transmit the received content to the wirelessly accessory upon detecting that the physical connection is complete.

3. The case of claim 1, wherein the battery is adapted to charge the wireless accessory when the wireless accessory is received within the housing.

4. The case of claim 1, wherein the input comprises a port adapted to receive a connector cable.

5. The case of claim 1, wherein the input comprises a connector integral with the case.

6. The case of claim 1, wherein the short range wireless pairing transmitter is adapted to transmit the received content to additional output devices.

7. The case of claim 6, wherein the short range wireless pairing transmitter is configured to multicast the received content to multiple wireless accessories at a given time.

8. The case of claim 7, wherein the case comprises one or more processors configured to detect a presence of an additional wireless accessory, and provide a prompt for instructions whether to transmit the received audio to the additional wireless accessory.

9. The case of claim 1, wherein the short range wireless pairing transmitter comprises a transceiver configured to receive input from the wireless accessory over the wireless connection.

10. The case of claim 1, wherein the case is configured to relay the received input to another device.

11. The case of claim 10, further comprising one or more processors configured to execute a command instructed by the received input.

12. A system, comprising:
a wireless accessory; and
a case for the wireless accessory, the case comprising:
a battery;
an input adapted to receive content from a simple electronic device through a physical connection; and
a short range wireless pairing transmitter configured to relay the received content to the wireless accessory over a wireless pairing connection.

13. The system of claim 12, wherein the case further comprises one or more processors configured to:
detect when the physical connection to the simple electronic device is complete; and automatically transmit the received content to the wirelessly accessory upon detecting that the physical connection is complete.

14. The system of claim 12, wherein the input comprises a port adapted to receive a connector cable.

15. The system of claim 12, wherein the short range wireless pairing transmitter is adapted to transmit the received content to additional output devices.

16. The system of claim 15, wherein the short range wireless pairing transmitter is configured to multicast the received content to multiple wireless accessories at a given time.

17. The system of claim 15, wherein the case comprises one or more processors configured to detect a presence of an additional wireless accessory, and provide a prompt for instructions whether to transmit the received audio to the additional wireless accessory.

18. A method, comprising:
detecting a physical connection between a case for a wireless electronic accessory and a simple electronic device;
receiving, at the case over the physical connection, content output from the simple electronic device; and
automatically transmitting, by the case, the received content over a short range wireless pairing connection to the wireless accessory.

19. The method of claim 18, further comprising multicasting the received content to multiple wireless accessories at a given time.

20. The method of claim 18, further comprising:
detecting a presence of an additional wireless accessory; and
providing a prompt for instructions whether to transmit the received audio to the additional wireless accessory.
